(19) United States
(12) Patent Application Publication
(10) Pub. No.: US 2011/0283456 A1
(43) Pub. Date: Nov. 24, 2011

(54) INGRESS/EGRESS ASSIST HANDLE

(76) Inventor: Fred Herman, Gahanna, OH (US)

(21) Appl. No.: 12/782,956

(22) Filed: May 19, 2010

(51) Int. Cl. A61G 7/053; B25G 1/00

(52) U.S. Cl. 5/662; 16/110.1

(57) ABSTRACT

A person-support apparatus comprises a frame, an endboard, and a handle assembly. The endboard is coupled to the frame. The endboard includes a grip. The handle assembly is configured to be removably coupled to the endboard. The handle assembly includes a handle configured to rotate with respect to the endboard between a first position and a second position. The handle is configured to assist a person during at least one of ingress and egress from the person-support apparatus in the first position.

### BACKGROUND OF THE DISCLOSURE

This disclosure relates generally to ingress/egress handles. More particularly, but not exclusively, one illustrative embodiment relates to a handle assembly configured to assist a person during ingress/egress to/from a person-support apparatus.

People occasionally need assistance during ingress/egress to/from person-support apparatuses. While various devices have been developed, there is still room for improvement. Thus a need persists for further contributions in this area of technology.

### SUMMARY OF THE DISCLOSURE

The present disclosure includes one or more of the features recited in the appended claims and/or the following features which, alone or in any combination, may comprise patentable subject matter.

One illustrative embodiment of the current disclosure can include an endboard with a handle assembly removably coupled thereto having a base and a handle pivotably coupled to the base and configured to move between a first position and second position with respect to the base.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person-support apparatus showing handle assembly according to one illustrative embodiment of the disclosure;

FIG. 2 is a perspective side view of the handle assembly of FIG. 1 coupled to an endboard;

FIG. 3 is a perspective side view of the handle assembly of FIG. 1;

FIG. 4 is a perspective top view of the handle assembly of FIG. 1;

FIG. 5 is an exploded side view of the handle assembly and the endboard of FIG. 2;

FIG. 6 is a perspective side view of the handle assembly of FIG. 1 in use position; and

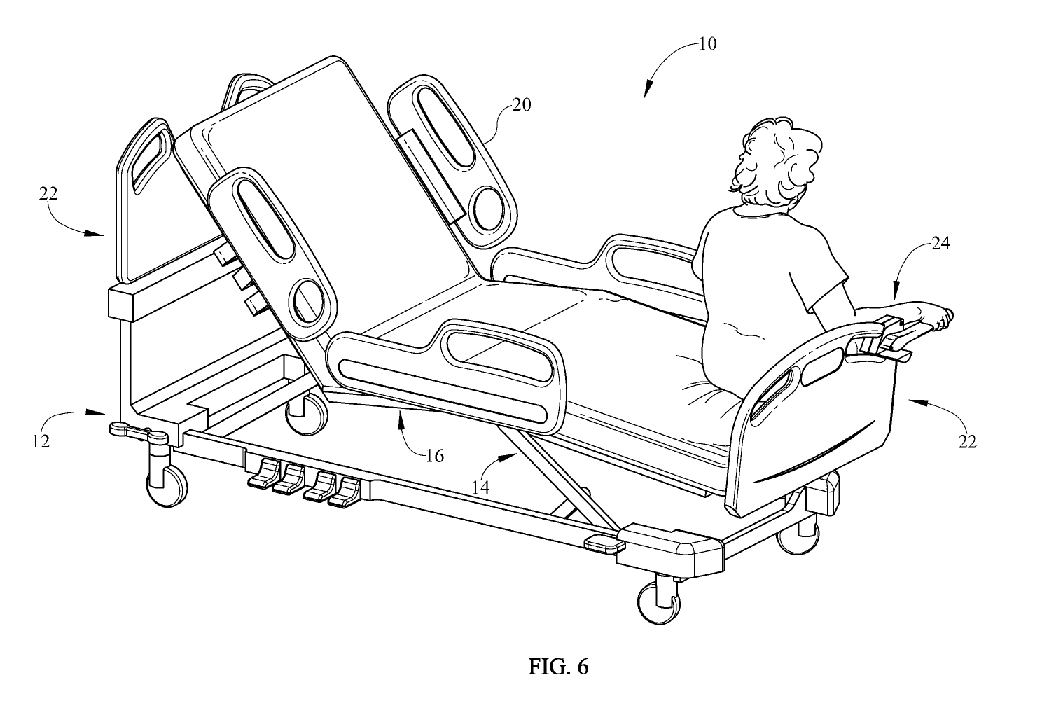

FIG. 7 is a perspective side view of the handle assembly of FIG. 1 in a storage position.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the current disclosure can include an endboard with a handle assembly removably coupled thereto having a base and a handle pivotably coupled to the base and configured to move between a first position and second position with respect to the base.

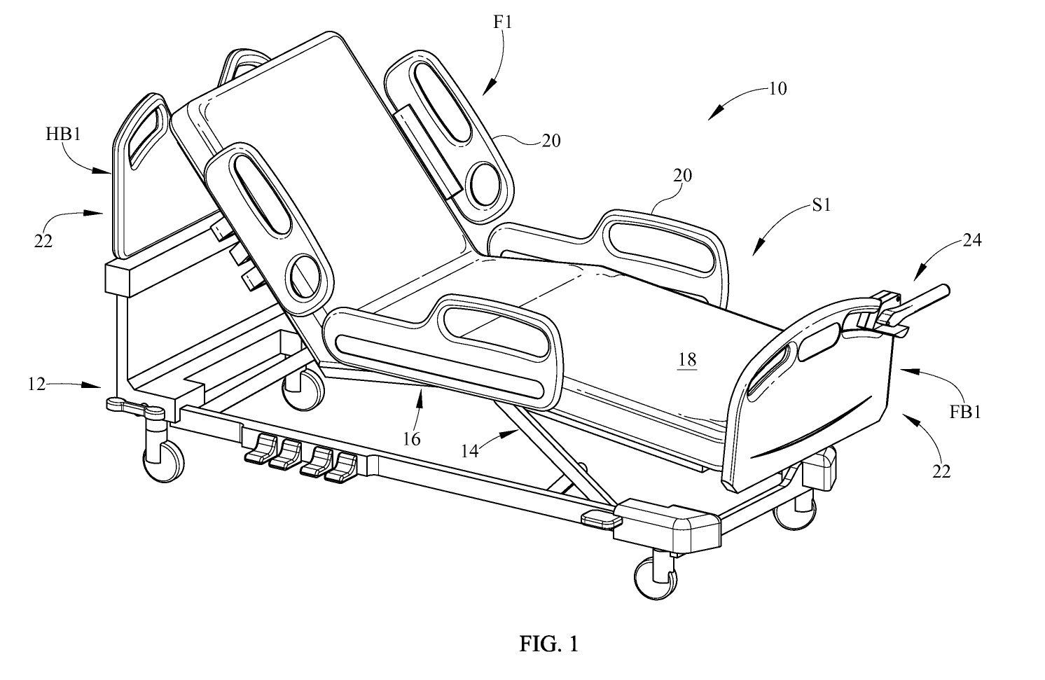

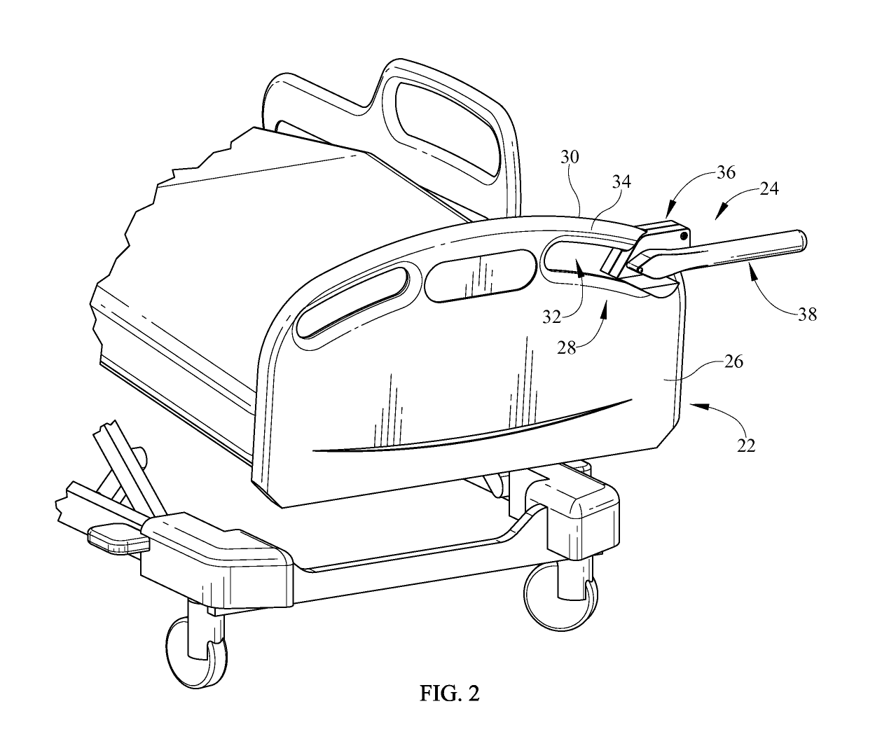

A person-support apparatus 10 according to one illustrative embodiment of the current disclosure is shown in FIGS. 1-2 & 6-7. The person-support apparatus 10 can have a first section F1 or head support section F1, where the head of a person can be positioned, and a second section S1 or a foot support section S1, where the feet of the person can be positioned. In one illustrative embodiment, the person-support apparatus 10 can be a hospital bed. It should be appreciated that the person-support apparatus 10 can also be a hospital stretcher or an operating table.

The person-support apparatus 10 can include a lower frame 12, a plurality of supports 14 coupled with the lower frame 12, and an upper frame 16 movably supported above the lower frame 12 by the supports 14 as shown in FIGS. 1-2 & 6-7. The supports 14 can be lift mechanisms 14 that can move the upper frame 16 with respect to the lower frame 12. In one illustrative embodiment, the person-support apparatus 10 can support a person-support surface 18 thereon. The upper frame 16 can include a plurality of siderails 20, a plurality of endboards 22, and a handle assembly 24. The endboards 22 can be a headboard HB 1 and/or a footboard FB 1 as shown in FIG. 1. It should be appreciated that the footboard FB 1 and the headboard HB 1 can be similarly constructed. The endboard 22 can include an endboard body 26 and an endboard grip portion 28. The endboard body 26 can include a perimeter edge 30. The endboard grip portion 28 can further include an opening 32 through the endboard body 26. The opening 32 can cooperate with the perimeter edge 30 to define an endboard grip 34. The endboard grip portion 28 can be configured to be gripped by a patient or a caregiver at the endboard grip 34.

The handle assembly 24 can be configured to be removably coupled to the endboard 22 as shown in FIGS. 1-2 & 5-7. It should be appreciated that the handle assembly 24 can also be coupled to the siderails 20. The handle assembly 24 can be gripped by a person to assist the person with ingress/egress to/from the person-support apparatus 10. The handle assembly 24 can include a base 36 and a handle 38. It should be appreciated that the handle assembly 24 can include a locking mechanism (not shown) that can maintain the orientation of the handle 38 with respect to the base 36; for example, a spring loaded lock that can be depressed to disengage the lock and allow the handle 38 to rotate, and released to re-engage the lock to maintain the orientation of the handle 38 with respect to the base 36.

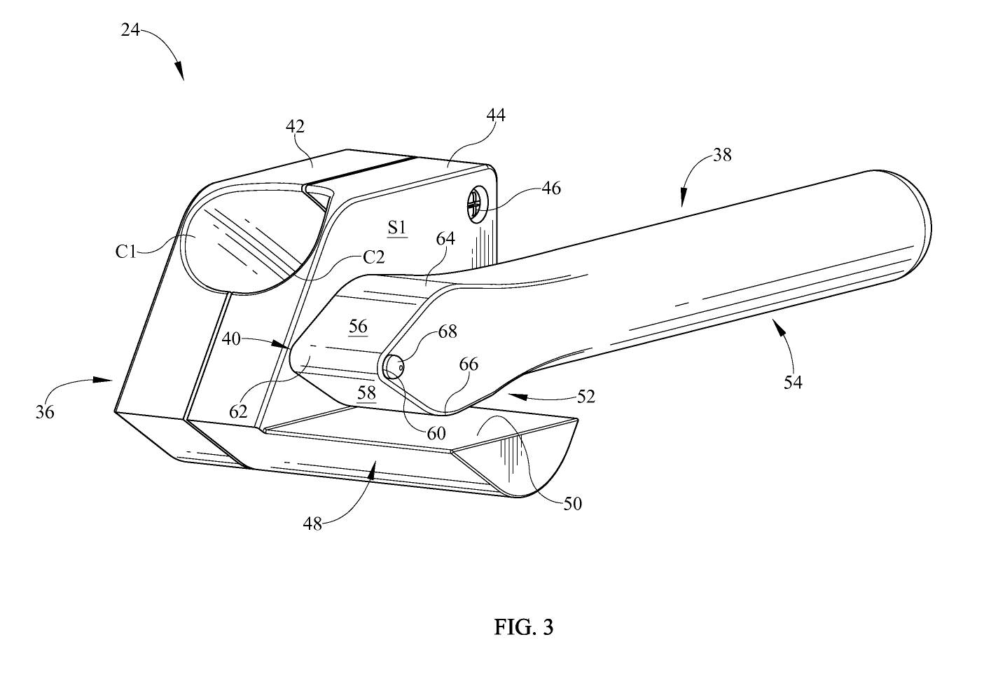

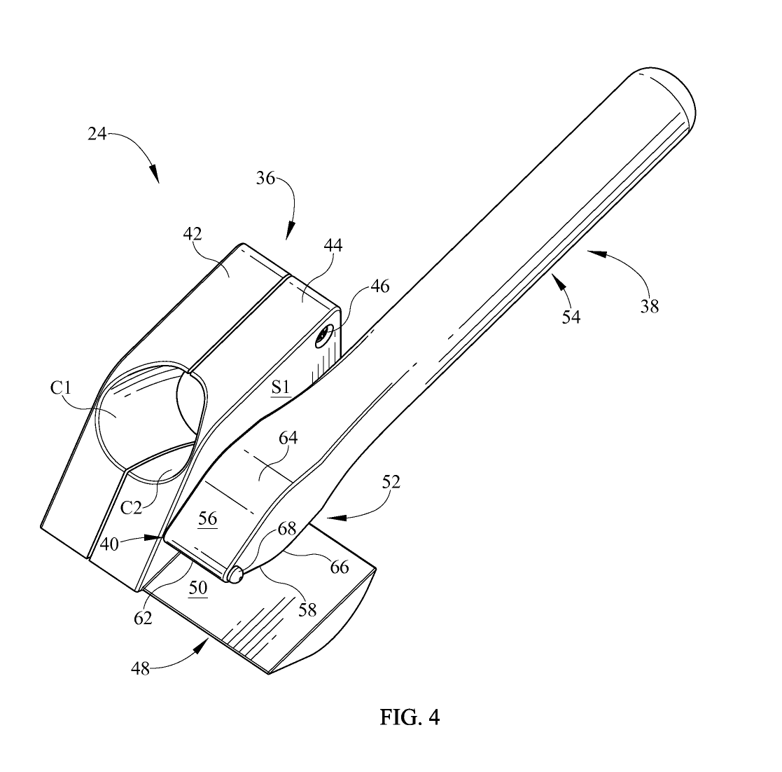

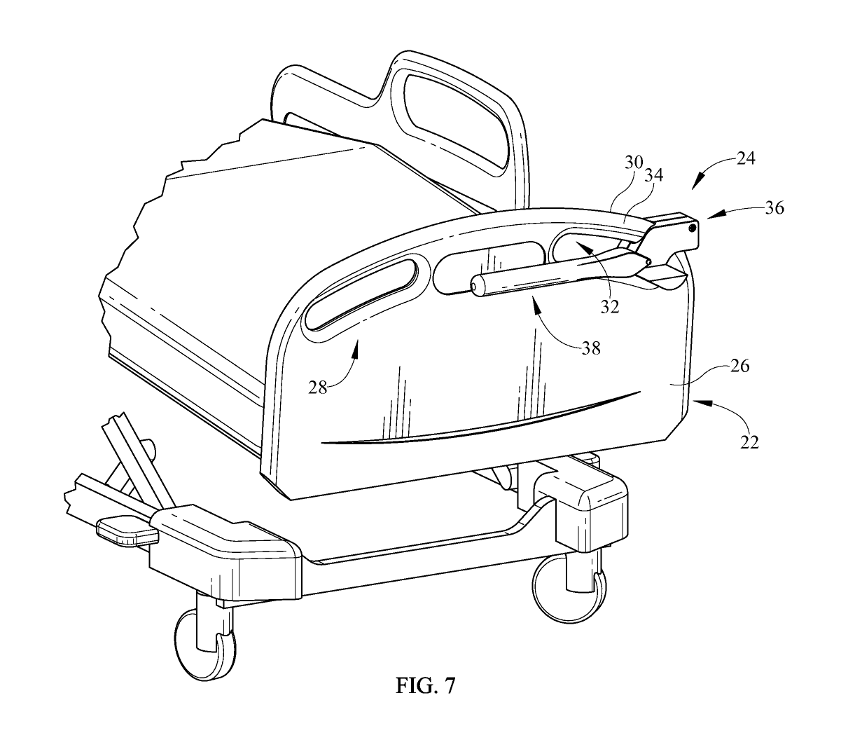

The handle 38 can be connected to the base 36 at a pivot point 40 as shown in FIGS. 3-4. The handle 38 can be configured to rotate about the pivot point 40 from a first position or a storage position, as shown in FIG. 7, to a second position or use position, as shown in FIGS. 1-2 & 6. In the use position the handle 38 can extend away from person-support apparatus 10. In the storage position the handle 38 can extend toward the person-support apparatus 10. In one illustrative embodiment, the handle 38 can be substantially horizontal in both the first position and the second position. It should be appreciated that the locking assembly can be configured to maintain the handle 38 in the first position and/or second position. It should also be appreciated that the handle 38 can be positioned at other angles with respect to the base 36 in the first position and the second position.

The base 36 can include a first base portion 42 and a second base portion 44 that can be removably coupled together to couple the base 36 to the endboard grip 34 as shown in FIGS. 3-5. In one illustrative embodiment the first base portion 42 can be present one side of the endboard grip portion 28 and second base portion 44 can be present on the other side of the endboard grip portion 28. The first base portion 42 can be removably coupled to the second base portion 44 by a fastener 46.

The first base portion 42 can include a first curved portion C1 that can be configured to engage a portion of the endboard grip portion 28 as shown in FIGS. 3-5. In one illustrative embodiment, the first curved portion C1 can be recessed into the first base portion 42 and can be configured to mimic the curved contour of a portion of the endboard grip portion 28. It should be appreciated that the first base portion 42 can include other portions shaped to mimic the contour of the endboard grip portion 28.

The second base portion 44 can include a support portion 48 and a second curved portion C2 as shown in FIGS. 3-5. It should be appreciated that the locking mechanism (not shown) can be used in addition to or in place of the support portion 48. The support portion 48 of the second base portion 44 can include a substantially planar surface 50 that can extend from a side S1 of the second base portion 44. The support portion 48 can be positioned beneath the handle 38 and can be configured to support and maintain the handle 38 in a substantially horizontal orientation when the handle 38 is in at least one of the first position and in the second position.

The second curved portion C2 can be recessed into the second base portion 44 and can be configured to engage a portion of the endboard grip portion 28 as shown in FIGS. 3-5. In one illustrative embodiment, the second curved portion C2 can be configured to mimic the curved contour of a portion of the endboard grip portion 28. The first curved portion C1 and the second curved portion C2 can cooperate with one another to engage a portion of the endboard grip portion 28 and couple the base 36 to the endboard grip portion 28.

The handle 38 can include a handle base portion 52 and a handle grip portion 54 as shown in FIGS. 3-5. In one illustrative embodiment, the handle grip portion 54 can be cylindrically shaped and can extend from the handle base portion 52. It should be appreciated that the handle grip portion 54 can be shaped to ergonomically assist the person during ingress/egress to/from the person-support apparatus 10. It should be appreciated that the handle grip portion 54 can include various surface textures.

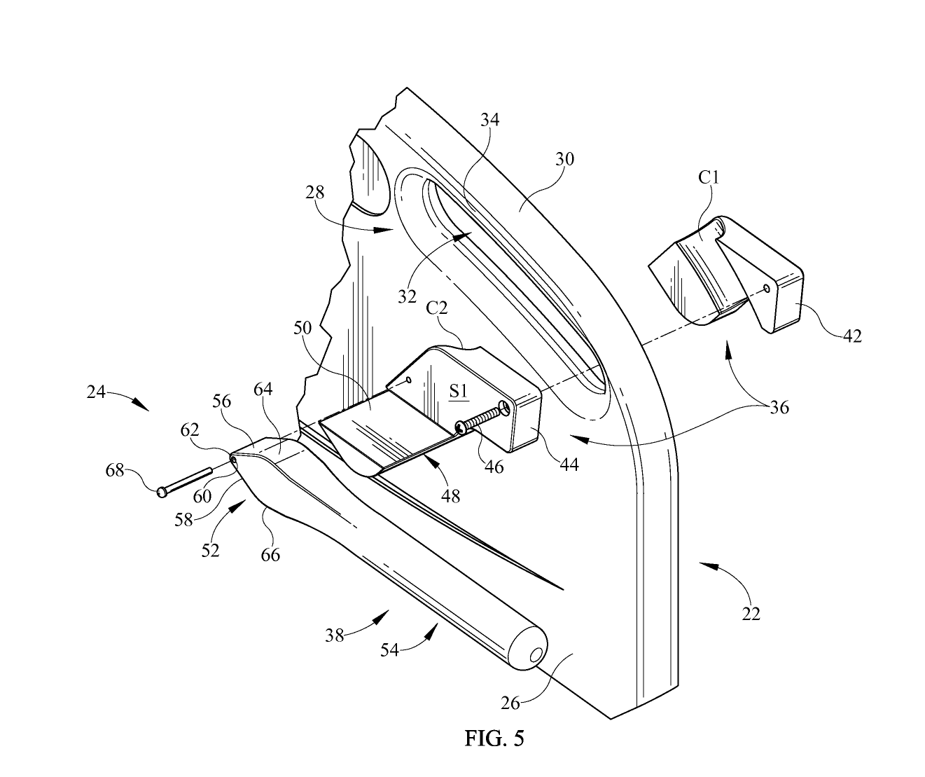

The handle base portion 52 can include a first sloped surface 56, a second sloped surface 58, and a pivot bore 60 as shown in FIGS. 3-5. The first sloped surface 56 can converge with the second sloped surface 58 at a first intersection 62 and can converge with the handle grip portion 54 at a second intersection 64 and a third intersection 66 as shown in FIG. 5. In one illustrative embodiment, the second intersection 64 and the third intersection 66 can engage the support portion 48 to maintain the substantially horizontal orientation of the handle 38 when the handle 38 is in the first position and the second position, respectively. In another illustrative embodiment, a portion of the first sloped surface 56 and/or the second sloped surface 58 can engage the support portion 48 to maintain the handle 38 in the first position and the second position.

The pivot bore 60 can be configured to receive a fastener 68 configured to rotatably couple the handle 38 to the base 36 such that the handle 38 is able to rotate between the first position and the second position with respect to the base 36 as shown in FIGS. 3-5. It should be appreciated that the fastener 68 can also be configured to couple the first base portion 42 to the second base portion 44. In one illustrative embodiment, the pivot bore 60 can be positioned proximate the first intersection 62.

Many other embodiments of the present disclosure are also envisioned. For example, a person-support apparatus comprises a frame, an endboard, and a handle assembly. The endboard is coupled to the frame. The endboard includes a grip. The handle assembly is configured to be removably coupled to the endboard. The handle assembly includes a handle configured to rotate with respect to the endboard between a first position and a second position. The handle is configured to assist a person during at least one of ingress and egress from the person-support apparatus in the first position.

In another example, an endboard assembly comprises an endboard and a handle assembly. The endboard includes a body with a perimeter edge and an opening through the body. The opening cooperates with the perimeter edge to define a grip. The handle assembly is coupled to the endboard. The handle assembly includes a base and a handle coupled to the base. The handle is configured to assist a person during at least one of ingress and egress from a person-support apparatus.

In another example, a handle assembly comprises a base and a handle. The base is configured to be removably coupled a grip portion of an endboard. The handle is pivotably coupled to the base. The handle is configured to move between a first position and a second position with respect to the base. The handle is configured to assist a person during at least one of ingress and egress from a person-support apparatus in the first position.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A person-support apparatus, comprising:
a frame;
an endboard coupled to the frame, the endboard including a grip; and
a handle assembly configured to be removably coupled to the endboard, the handle assembly including a handle configured to rotate with respect to the endboard between a first position and a second position, wherein the handle is configured to assist a person during at least one of ingress and egress from the person-support apparatus in the first position.

2. The person-support apparatus of claim 1, wherein the handle assembly is configured to couple to the grip.

3. The person-support apparatus of claim 1, wherein the handle assembly includes a base, the base includes a curved portion configured to engage a portion of the grip.

4. The person-support apparatus of claim 1, wherein the handle assembly includes a base having a first portion and a second portion, the first portion cooperating with the second portion to couple the handle assembly to the endboard.

5. The person-support apparatus of claim 4, wherein the first portion and the second portion include curved portions configured to engage a portion of the endboard.

6. The person-support apparatus of claim 1, wherein the handle assembly includes a base with a first portion and a second portion, the first portion includes a support portion configured to support the handle in at least one of the first position and the second position.

7. The person-support apparatus of claim 1, wherein the handle is ergonomically shaped.

8. An endboard assembly, comprising:
an endboard including a body with a perimeter edge and an opening through the body, the opening cooperating with the perimeter edge to define a grip; and
a handle assembly coupled to the endboard, the handle assembly including a base and a handle coupled to the base, wherein the wherein the handle is configured to assist a person during at least one of ingress and egress from a person-support apparatus.

9. The endboard assembly of claim 8, wherein the handle assembly is configured to couple to the grip of the endboard.

10. The endboard assembly of claim 8, wherein the base includes a curved portion configured to engage a portion of the grip.

11. The endboard assembly of claim 8, wherein the base includes a first portion and a second portion, the first portion cooperating with the second portion to couple the handle assembly to the endboard.

12. The endboard assembly of claim 8, wherein the handle assembly includes a locking mechanism configured to selectively maintain the orientation of the handle with respect to the base.

13. The endboard assembly of claim 8, wherein the handle is configured to move between a first position and a second position with respect to the base.

14. The endboard assembly of claim 13, wherein the base includes a support portion configured to support the handle in at least one of the first position and the second position.

15. The endboard assembly of claim 8, wherein the handle is ergonomically shaped.

16. An handle assembly, comprising:
a base configured to be removably coupled a grip portion of an endboard; and
a handle pivotably coupled to the base, the handle being configured to move between a first position and a second position with respect to the base, wherein the handle is configured to assist a person during at least one of ingress and egress from a person-support apparatus in the first position.

17. The person-support apparatus of claim 16, wherein the base includes a support portion, a portion of the handle being configured to engage the support portion to maintain the handle in at least one of the first position and the second position.

18. The person-support apparatus of claim 16, wherein the base includes a curved portion configured to engage a portion of the grip.

19. The person-support apparatus of claim 16, wherein the base includes a first portion and a second portion configured to removably couple to the second portion, the first portion cooperating with the second portion to couple the handle assembly to the grip.

20. The person-support apparatus of claim 19, wherein the first portion and the second portion include curved portions configured to engage a portion of the grip.

21. The person-support apparatus of claim 16 further comprising a locking mechanism configured to selectively maintain the orientation of the handle with respect to the base.
